(19) United States
(12) Patent Application Publication
(10) Pub. No.: US 2023/0079624 A1
(43) Pub. Date: Mar. 16, 2023

(54) TRAVEL PATH GENERATION DEVICE

(71) Applicant: Mitsubishi Electric Corporation, Tokyo (JP)

(72) Inventors: Kazushi MAEDA, Tokyo (JP); Yu TAKEUCHI, Tokyo (JP); Toshihide SATAKE, Tokyo (JP); Shuuhei NAKATSUJI, Tokyo (JP)

(73) Assignee: Mitsubishi Electric Corporation, Tokyo (JP)

(21) Appl. No.: 17/801,339

(22) PCT Filed: Apr. 10, 2020
(86) PCT No.: PCT/JP2020/016142

§ 371 Date: Aug. 22, 2022

(51) Int. Cl. B60W 60/00

(52) U.S. Cl. CPC B60W 60/001; B60W 2520/00

(57) ABSTRACT

The travel path generation device includes; a first path generation part that outputs a bird's-eye view travel path constituted of a bird's-eye view curvature component, a bird's-eye view angle component, and a bird's-eye view lateral position component; a second path generation part that outputs an autonomous travel path constituted of an autonomous curvature component, an autonomous angle component, and an autonomous lateral position component; and a path generation part that receives the outputs of the first path generation part and the second path generation part, sets up, based on the bird's-eye view curvature component, the autonomous angle component, and the autonomous lateral position component, a curvature component of the travel path of the host vehicle, an angle component to the travel path of the host vehicle, and a lateral position component to the travel path of the host vehicle, and generates the travel path of the host vehicle.

### FIELD OF THE INVENTION

The present application relates to the field of a travel path generation device.

### BACKGROUND OF THE INVENTION

In recent years, with respect to vehicles, various types of devices, which use the technology of automatic operation, have been developed and proposed, so that a driver could operate a vehicle more comfortably and more safely. For example, in the Patent Document 1, a vehicle control device for following an optimal path is proposed, in which the vehicle control device detects an autonomous sensor travel path which is computed out by the information from a front recognition camera, and a bird's-eye view sensor travel path which is computed out from high precision map information and GNSS (Global Navigation Satellite System), such as GPS, where the high precision map information includes the point group of a traffic lane center, white line position information, and the like, of the peripheral road of a host vehicle. In addition, the vehicle control device computes out a unified travel path, which is in accordance with a weight for each of the travel paths, where the weight is determined based on the reliability, judged from the detection state of the front recognition camera, and the reliability, judged from the receiving state of the GNSS.

### CITATION LIST

### Patent Literature

Patent Document 1: Japanese Patent No. 6055525

### SUMMARY OF THE INVENTION

### Technical Problem

In general, a path is the one which is expressed in a polynomial equation, and equations for a bird's-eye view sensor travel path, an autonomous sensor travel path, and an integrated path are represented respectively by the Equation (1) to the Equation (3). In each of the Equations, the coefficient of a first term (a second order term) represents a curvature component of a path (hereafter referred to as a curvature component), the coefficient of a second term (a first order term) represents an angle component between a host vehicle and a path (hereafter referred to as an angle component), and the coefficient of a third term (an intercept term) represents a lateral position component between a host vehicle and a path (hereafter referred to as a lateral position component).

### [Equation 1]

Eq. 1

path_sat(x)=C2_sat×x²+C1_sat×x+C0_sat (1)

### [Equation 2]

Eq. 2

path_cam(x)=C2_cam×x²+C1_cam×x+C0_cam (2)

### [Equation 3]

Eq. 3

path_all(x)=C2_all×x²+C1_all×x+C0_all (3)

Moreover, respective components of an integrated path are represented by the Equation (4) to the Equation (6). In each of the Equations, symbol w2_sat, symbol w1_sat, and symbol w0_sat represent a weight for each of the components of a bird's-eye view sensor travel path, and symbol w2_cam, symbol w1_cam, and symbol w0_cam represent a weight for each of the components of an autonomous sensor travel path. A plurality of paths is averaged with a weight (weighted mean average) among their respective components, and thereby, each of the components of an integrated path can be obtained.

### [Equation 4]

Eq. 4

C2_all=w2_sat×C2_sat+w2_cam×C2_cam (4)

(where w2_sat+w2_cam=1)

### [Equation 5]

Eq. 5

C1_all=w1_sat×C1_sat+w1_cam×C1_cam (5)

(where w1_sat+w1_cam=1)

### [Equation 6]

Eq. 6

C0_all=w0_sat×C0_sat+w0_cam×C0_cam (6)

(where w0_sat+w0_cam=1)

It is worth noticing that, in each of the equations, the symbol w2_sat is a weight for the bird's-eye view sensor drive path in the curvature component of an integrated path; the symbol w2_cam is a weight for the autonomous sensor drive path in the curvature component of an integrated path; the symbol w1_sat is a weight for the bird's-eye view sensor drive path in the angle component of an integrated path; the symbol w1_cam is a weight for the autonomous sensor drive path in the angle component of an integrated path; the symbol w0_sat is a weight for the bird's-eye view sensor drive path in the lateral position component of an integrated path; and the symbol w0_cam is a weight for the autonomous sensor drive path in the lateral position component of an integrated path. A plurality of paths is averaged with a weight (weighted mean average) among their respective components, and thereby, each of the components of an integrated path can be obtained.

Here, according to the technology which is proposed in the Patent Document 1, in the vicinity of a tunnel entrance or so, a front recognition camera is hard to recognize the inside of a tunnel. Assuming that the accuracy of the angle component and curvature component of an autonomous sensor travel path is low, as for the angle component and curvature component of an integrated path, the weight for a bird's-eye view sensor travel path is set to be higher than the weight for an autonomous sensor travel path.

However, in practice, due to the influence of errors in the position and azimuth by the GNSS, the lateral position component and angle component of a bird's-eye view sensor travel path is lower in accuracy than an autonomous sensor travel path. Therefore, even if, as for the angle component of an integrated path, the weight of a bird's-eye view sensor travel path is set up to be high, there remains a subject that the conventional averaging with a weight cannot generate an optimal integrated path.

The present application aims at generating a highly precise path, compared with the existing path generation device, so that optimal control may be performed according to the state where a host vehicle is placed.

### Solution to Problem

A travel path generation device according to the present application, includes;

a first path generation part that outputs, based on road map data, a bird's-eye view travel path which is constituted of a bird's-eye view curvature component, a bird's-eye view angle component of a host vehicle, and a bird's-eye view lateral position component of the host vehicle,

a second path generation part that outputs, based on information from a sensor which is mounted in the host vehicle, an autonomous travel path which is constituted of an autonomous curvature component, an autonomous angle component of the host vehicle, and an autonomous lateral position component of the host vehicle, and

a path generation part that receives outputs of the first path generation part and the second path generation part; sets up a curvature component of a travel path of the host vehicle, an angle component to the travel path of the host vehicle, and a lateral position component to the travel path of the host vehicle, based on the bird's-eye view curvature component, the autonomous angle component, and the autonomous lateral position component; and generates the travel path of the host vehicle.

### Advantageous Effects of Invention

The travel path generation device according to the present application generates and represents a travel path, using a curvature component, an angle component, and a lateral position component, of a bird's-eye view travel path and an autonomous travel path. Thereby, it becomes possible to generate an integrated path with an accuracy higher than before.

### BRIEF EXPLANATION OF DRAWINGS

FIG. 1 is a block diagram for showing the constitution of a vehicle control device, according to the Embodiment 1.

FIG. 2 is a diagram for explaining the operation of a bird's-eye view sensor travel path generation part, according to the Embodiment 1.

FIG. 3 is a flow chart for showing the operation of the vehicle control device, according to the Embodiment 1.

FIG. 4 is a drawing for explaining a path coordinate system of a bird's-eye view sensor travel path generation part and an autonomous sensor travel path generation part, according to the Embodiment 1.

FIG. 5 is a block diagram for showing another constitution of the vehicle control device, according to the Embodiment 1.

FIG. 6 is a block diagram for showing another configuration of the travel path weight set up part, according to the Embodiment 1.

FIG. 7 is a flow chart for showing the operation of another configuration of the travel path weight set up part, according to the Embodiment 1.

FIG. 8 is a block diagram for showing another constitution of the vehicle control device, according to the Embodiment 1.

FIG. 9 is a block diagram for showing another configuration of the travel path weight set up part, according to the Embodiment 1.

FIG. 10 is a flow chart for showing the operation of another configuration of the travel path weight set up part, according to the Embodiment 1.

FIG. 11 is a block diagram for showing the constitution of another configuration of the vehicle control device, according to the Embodiment 1.

FIG. 12 is a block diagram for showing another configuration of the travel path weight set up part, according to the Embodiment 1.

FIG. 13 is a flow chart for showing the operation of another configuration of the travel path weight set up part, according to the Embodiment 1.

FIG. 14 is a block diagram for showing the constitution of the vehicle control device, according to the Embodiment 2.

FIG. 15 is a block diagram for showing the travel path weight set up part, according to the Embodiment 2.

FIG. 16 is a flow chart for showing the operation of the travel path weight set up part, according to the Embodiment 2.

FIG. 17 is a diagram for explaining the operation of the bird's-eye view sensor travel path generation part, according to the Embodiment 2.

FIG. 18 is a block diagram for showing the constitution of another configuration of the vehicle control device, according to the Embodiment 2.

FIG. 19 is a block diagram for showing another configuration of the travel path weight set up part, according to the Embodiment 2.

FIG. 20 is a flow chart for showing the operation of another configuration of the travel path weight set up part, according to the Embodiment 2.

FIG. 21 is a block diagram for showing an example of the hardware of the travel path generation device according to the Embodiment 1 and the Embodiment 2.

### DESCRIPTION OF EMBODIMENTS

### Embodiment 1

Hereinafter, explanation will be made about the Embodiment 1 based on drawings. It is worth noticing that, in the drawings, each of the same symbols or numerals shows a portion which is the same or a corresponding part.

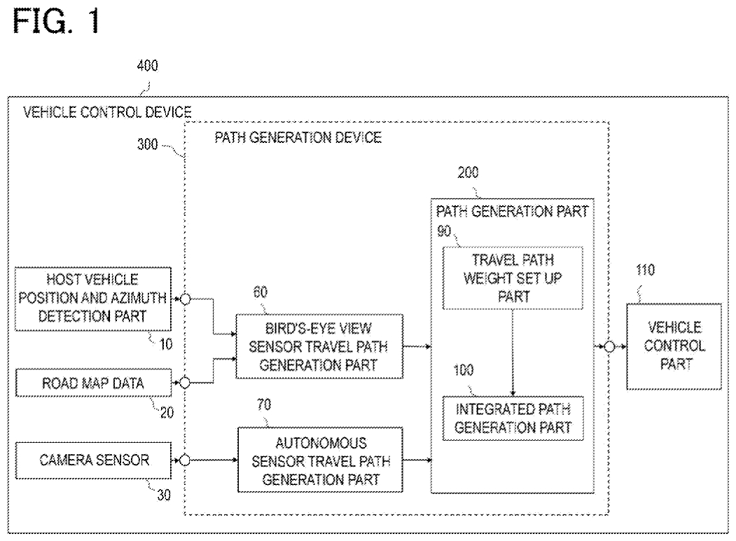

FIG. 1 is a block diagram showing the constitution of a vehicle control device 400 according to the Embodiment 1.

As shown in FIG. 1, a path generation device 300 receives the information from a host vehicle position and azimuth detection part 10, a road map data 20, and a camera sensor 30, and then, outputs the information on an integrated path which is used for the control in a vehicle control part 110. The host vehicle position and azimuth detection part 10 outputs the absolute coordinate and azimuth of a host vehicle, based on the positioning information from the GNSS. In the road map data 20, the target point sequence information on the center of a peripheral driving lane of a host vehicle is included. The camera sensor 30 is mounted in a host vehicle, and outputs the division line information of a vehicle lane ahead of a host vehicle. The path generation device 300 is equipped with a bird's-eye view sensor travel path generation part (a first travel path generation part) 60, an autonomous sensor travel path generation part (a second travel path generation part) 70, a travel path weight set up part 90, and an integrated path generation part 100. Here, the path generation part 200 is configured by the travel path weight set up part 90 and the integrated path generation part 100.

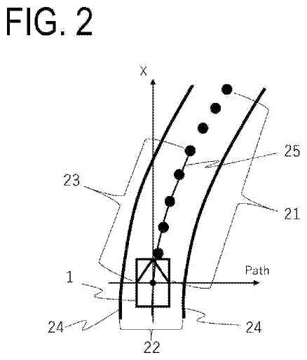

From the host vehicle position and azimuth detection part 10 and the road map data 20, a specific section which is ahead of a host vehicle (referred to as a look ahead distance) is adopted as an approximation range. In addition, the bird's-eye view sensor travel path generation part 60 outputs the result of approximation by a polynomial equation, where the approximation is carried out, within the approximation range, to express a traffic lane on which a host vehicle should travel. That is, as shown in FIG. 2, regarding the travel of a host vehicle 1, host traffic lanes 22, which are restricted using the division line information 24 of a road, are set up. In addition, a specific section which is ahead of the host vehicle 1 is adopted as an approximation range 23. Further, an approximated curve 25, which covers the approximation range 23, is computed out, where the approximated curve is expressed by a polynomial equation, which is in accordance with the target point sequence information 21. (Refer to FIG. 2). It is worth noticing that, a look ahead distance is a variable value, which depends on the vehicle speed. When the vehicle speed is high, the look ahead distance becomes long, and when the vehicle speed is low, the look ahead distance becomes short. On the basis of the division line information of a front traffic lane, obtained by the camera sensor 30, the autonomous sensor travel path generation part 70 outputs the result of approximation by a polynomial equation, which expresses a travel path on which a host vehicle should travel. As an approximation result by a polynomial equation, the bird's-eye view sensor travel path generation part 60 and the autonomous sensor travel path generation part 70 compute out each of the coefficients of a lateral position deviation, an angle deviation, and a path curvature, toward a host vehicle and an approximated curve. In addition, the bird's-eye view sensor travel path generation part 60 and the autonomous sensor travel path generation part 70 output a bird's-eye view travel path and an autonomous travel path, respectively,

It is worth noticing that, the bird's-eye view sensor travel path is based on the road map data. Thereby, there is a benefit that the bird's-eye view sensor travel path can express the curvature of a path with a sufficient accuracy, rather than an autonomous sensor travel path. Moreover, the autonomous sensor travel path is based on graphical image information with a camera. Thereby, there is a benefit that the autonomous sensor travel path can express the angle between a host vehicle and a path, and the lateral position between a host vehicle and a path, with a sufficient accuracy, rather than the bird's-eye view sensor travel path, which is subject to the influence of errors in the position or azimuth by the GNSS. It is worth noticing that, “bird's-eye view” denotes a state to look down the bottom from a high place, and “bird's-eye view like” denotes a state close to look down over the bottom from a high position. On the other hand, “autonomous type” denotes a state to recognize the circumference and respond to it, using various kinds of sensors which are mounted in a car, such as a camera or a sonar.

The travel path weight set up part 90 sets up the weight which denotes the probability between both travel paths of the bird's-eye view sensor travel path generation part 60 and the autonomous sensor travel path generation part 70. In the integrated path generation part 100, an integrated path, which is a single path, is output from the information of the bird's-eye view sensor travel path generation part 60, the autonomous sensor travel path generation part 70, and the travel path weight set up part 90.

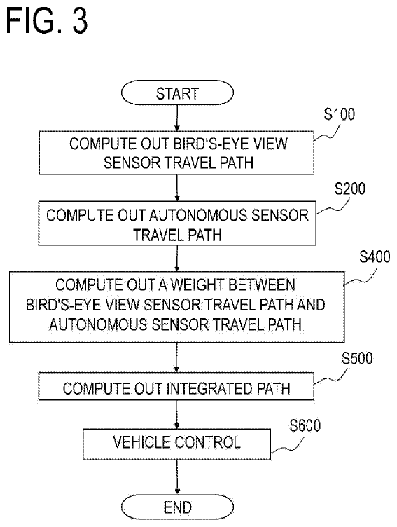

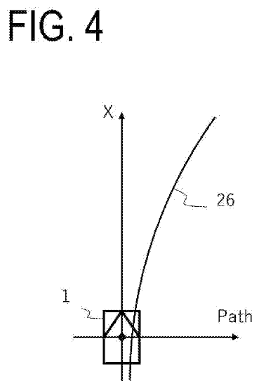

Next, explanation will be made about the overall operation of the vehicle control device according to the Embodiment 1, using the flow chart of FIG. 3. It is worth noticing that, the flow chart of FIG. 3 is repeatedly performed while a vehicle is travelling. First, from the information of the host vehicle position and azimuth detection part 10 and the road map data 20, the bird's-eye view sensor travel path generation part 60 computes out the state of a host vehicle and the central point sequence of a traffic lane on which the host vehicle is travelling presently, as an approximate expression on a host vehicle reference frame which is shown in FIG. 4, and expresses the state as the Equation (1) (Step S100). Next, like the case mentioned above, from the division line information of a front traffic lane obtained by the camera sensor 30, the autonomous sensor travel path generation part 70 computes out the travel path 26 on which a host vehicle should travel, as an approximate expression on a host vehicle reference frame of FIG. 4, and expresses the state as the Equation (2) (Step S200). In the Equation (1) and the Equation (2), the first term represents the curvature of each of the paths, the second term represents the angle of a host vehicle toward each of the paths, the second term represents the lateral position of a host vehicle toward each of the paths. Next, the travel path weight set up part 90 sets up a weight to each of the travel paths which are computed out in Step S100 and Step S200. However, in the present Embodiment, a predetermined value is set up for the weight (Step S400).

Here, as for the curvature component of a path, the weight of a bird's-eye view sensor travel path is set up to be higher than the weight of an autonomous sensor travel path, and as for the angle component between a host vehicle and a path, and the lateral position component between a host vehicle and a path, a predetermined value is set up so that the weight of an autonomous sensor travel path may become larger than the weight of a bird's-eye view sensor travel path. It is worth noticing that, the weight of a bird's-eye view sensor travel path and the weight of an autonomous sensor travel path are the ones which become 1 when they are added. For example, as for the curvature component of a path, the weight of a bird's-eye view sensor travel path is set up to be 0.7 and the weight of an autonomous sensor travel path is set up to be 0.3; and as for the angle component between a host vehicle and a path, and the lateral position component between a host vehicle and a path, the weight of an autonomous sensor travel path is set up to be 0.7 and the weight of a bird's-eye view sensor travel path is set up to be 0.3. Or it is allowed that, as for the curvature component of a path, the weight of a bird's-eye view sensor travel path is set up to be 1, and the weight of an autonomous sensor travel path is set up to be 0; and as for the angle component between a host vehicle and a path, and the lateral position component between a host vehicle and a path, the weight of an autonomous sensor travel path is set up to be 1 and the weight of a bird's-eye view sensor travel path is set up to be 0. It is worth noticing that, in a case where, as for the curvature component of a path, the weight of a bird's-eye view sensor travel path is set up to be 1 and the weight of an autonomous sensor travel path is set up to be 0; and as for the angle component between a host vehicle and a path, and the lateral position component between a host vehicle and a path, the weight of an autonomous sensor travel path is set up to be 1 and the weight of a bird's-eye view sensor travel path is set up to be 0, it will become substantially a case where a bird's-eye view sensor travel path is used for the curvature component of a path; and an autonomous sensor travel path is used for the angle component between a host vehicle and a path, and the lateral position component between a host vehicle and a path.

After that, from the coefficient of each of the paths which are computed out in Step S100 and Step S200, and the weight to each of the paths which are set up in Step S400, the integrated path generation part 100 computes out the coefficient of an integrated path (the Equation (3)) on which a host vehicle should travel, by the Equation (4) to the Equation (6) (Step S500).

Finally, using the integrated path, the vehicle control part 110 performs vehicle control (Step S600). It is worth noticing that, in the computing out operation of each of the paths in Step S100 and Step S200, computed out results of one side do not influence the computing out operation of the other side. Therefore, there are no restrictions about an order of computation out.

In this way, the path generation device according to the present Embodiment carries out the averaging with a weight among each of the components of a plurality of paths. At that time, as for the curvature component of a path, the weight of a bird's-eye view sensor travel path is set up to be higher than the weight of an autonomous sensor travel path; and, as for the angle component between a host vehicle and a path, and the lateral position component between a host vehicle and a path, the weight of an autonomous sensor travel path is set up to be higher than the weight of a bird's-eye view sensor travel path. Then, it become possible to generate an integrated path with an accuracy higher than before.

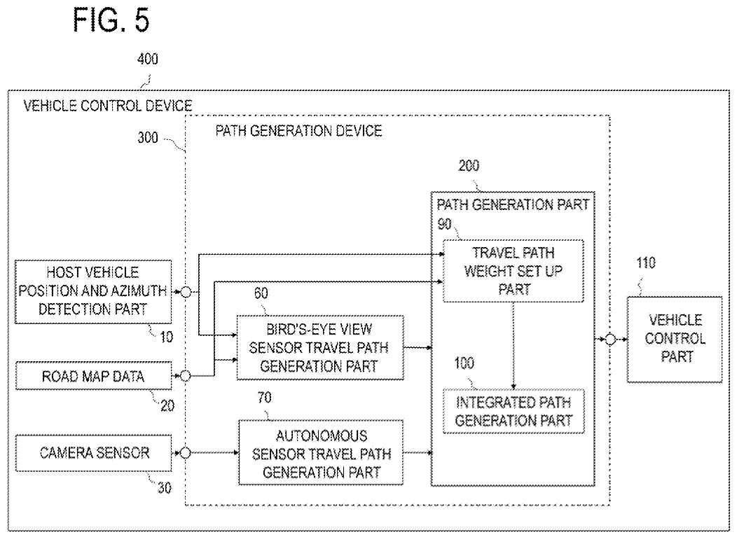

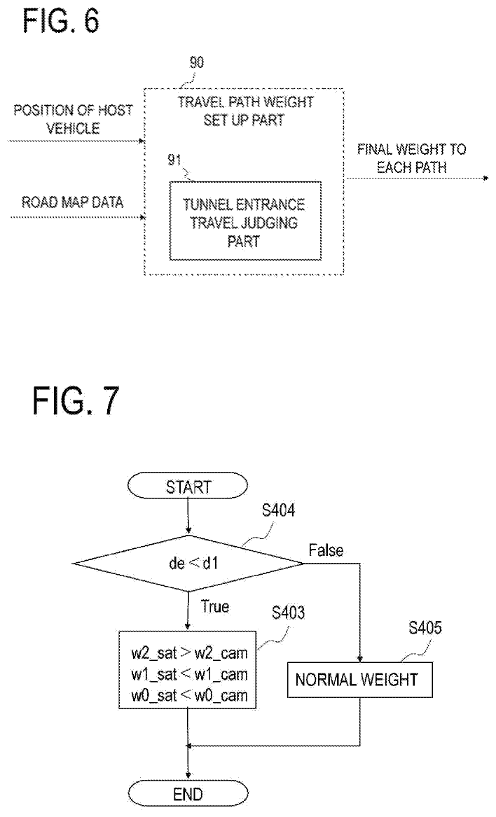

It is worth noticing that, at all times in the present Embodiment, as for the curvature component of a path, the weight of a bird's-eye view sensor travel path is set up to be higher than the weight of an autonomous sensor travel path; and as for the angle component and the lateral position component, the weight of an autonomous sensor travel path is set up to be higher than the weight of a bird's-eye view sensor travel path. However, it will bring a better situation, if, only in the situation where the curvature accuracy of an autonomous sensor travel path becomes low, the set up of a weight mentioned above is carried out, in addition, in other situations, the weight is set up, as before, based on the reliability which is judged from the detection state of a front recognition camera, and in addition, the reliability which is judged from a receiving state of the GNSS. In that case, for example, the vehicle control device is configured in the constitution of FIG. 5, and in addition, the travel path weight set up part 90 is configured in that of FIG. 6. The vehicle control device is equipped with a tunnel entrance travel judging part 91, and is configured to judge whether the host vehicle is near a tunnel or not, from a host vehicle position and road map data. Further, in Step S400, the travel path weight set up part judges whether the distance de, a distance from the host vehicle to a tunnel, is shorter than the set threshold value d1, based on the flow chart of FIG. 7 (whether the host vehicle is travelling near the entrance of a tunnel or not). Only when the travel path weight set up part judges that the host vehicle is travelling near the entrance of a tunnel, it is beneficial that, as for the curvature component of a path, the weight of a bird's-eye view sensor travel path is set up to be higher than the weight of an autonomous sensor travel path, and, as for the angle component and the lateral position component, the weight of an autonomous sensor travel path is set up to be higher than the weight of a bird's-eye view sensor travel path.

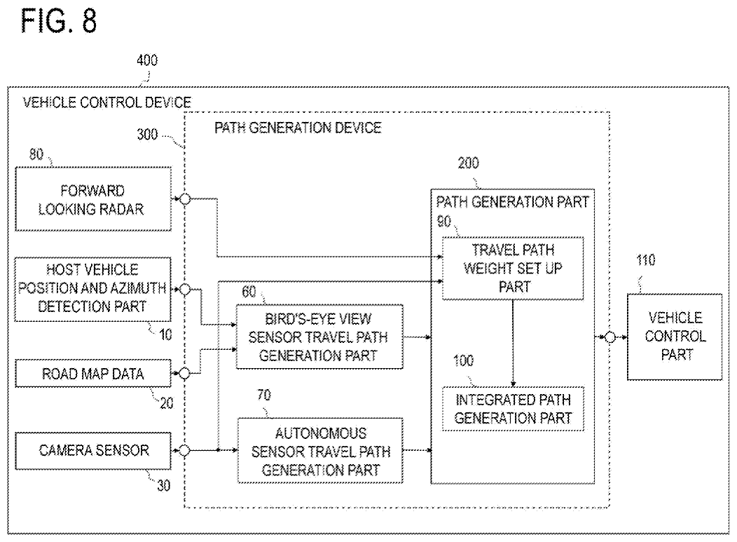

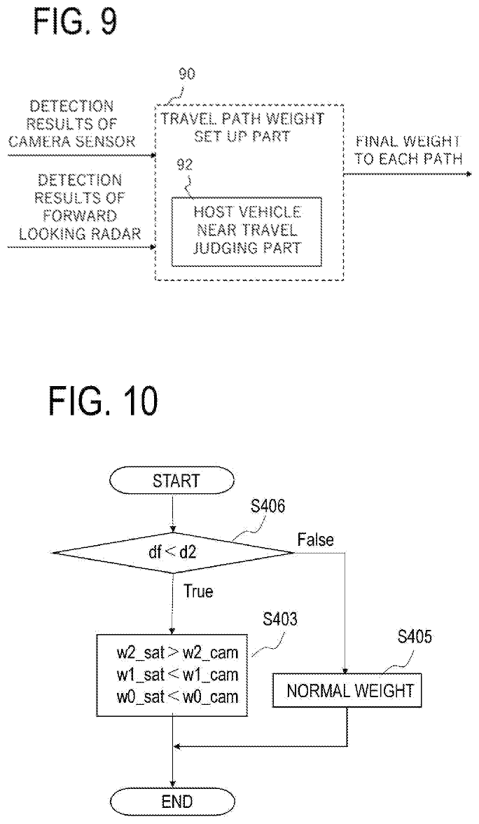

Or, as shown in FIG. 8, the vehicle control device 400 is configured so that the detection results of a forward looking radar 40 and the detection results of a camera sensor 30 may be output to the travel path weight set up part 90. In addition, as shown in FIG. 9, the travel path weight set up part 90 is equipped with a host vehicle near travel judging part 92 which judges whether a vehicle is preceding and travelling within a predetermined distance from the host vehicle or not. Further, the vehicle control device is configured to judge whether a leading vehicle is travelling within a predetermined distance from the host vehicle. In Step S400, the travel path weight set up part 90 judges whether the distance df, a distance from a host vehicle to a leading vehicle, is shorter or not than a set threshold value d2, based on the flow chart of FIG. 10 (namely, a leading vehicle is traveling within a predetermined distance from the host vehicle). Only when the travel path weight set up part judges that the threshold value is shorter, it is beneficial that, as for the curvature component of a path, the weight of a bird's-eye view sensor travel path is set up to be higher than the weight of an autonomous sensor travel path, and, as for the angle component and the lateral position component, the weight of an autonomous sensor travel path is set up to be higher than the weight of a bird's-eye view sensor travel path.

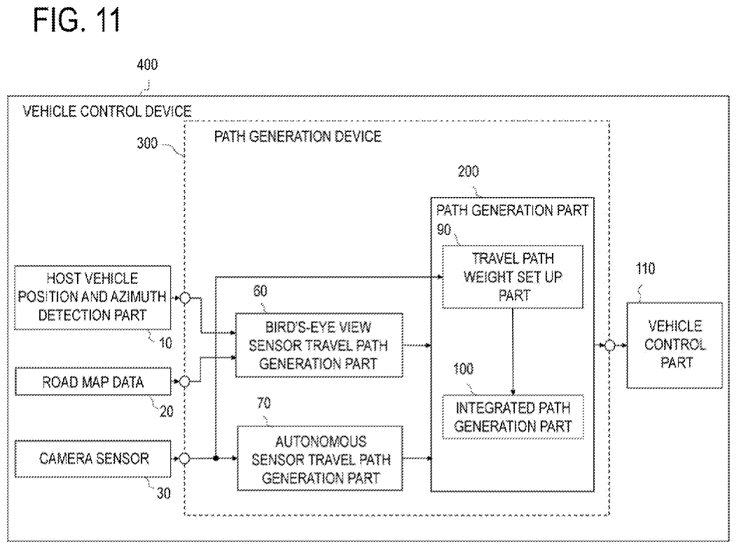

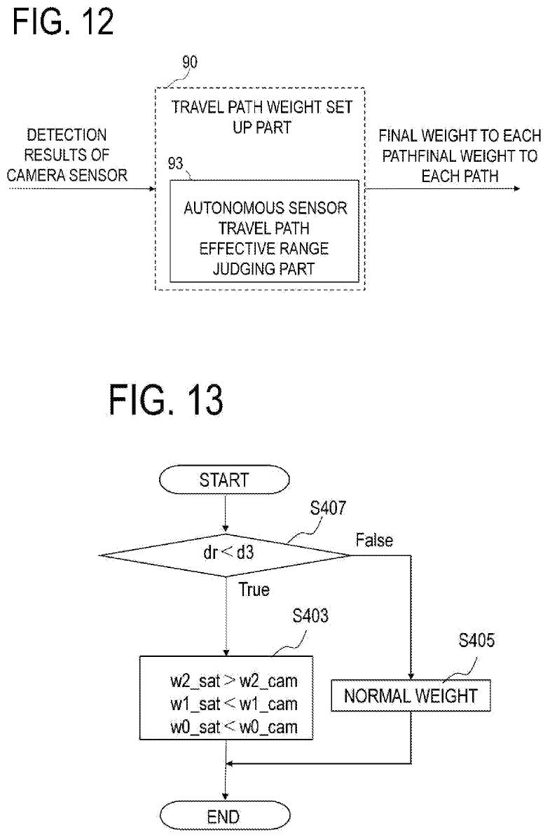

Or, the vehicle control device 400 is configured in the constitution which is shown in FIG. 11. In addition, the travel path weight set up part 90 is equipped with an autonomous sensor travel path effective range judging part 93, as shown in FIG. 12, and the vehicle control device is configured to judge whether the effective range of the division line information of a front traffic lane (namely, the effective range of an autonomous sensor travel path) is short or not, from a camera. Further, in Step S400, the travel path weight set up part 90 judges whether the effective range dr of the autonomous sensor travel path is shorter or not than a set threshold value d3, based on the flow chart of FIG. 13. Only when the travel path weight set up part judges that the effective range is shorter, it is beneficial that, as for the curvature component of a path, the weight of a bird's-eye view sensor travel path is set up to be higher than the weight of an autonomous sensor travel path, and in addition, as for the angle component and the lateral position component, the weight of an autonomous sensor travel path is set up to be higher than the weight of a bird's-eye view sensor travel path.

### Embodiment 2

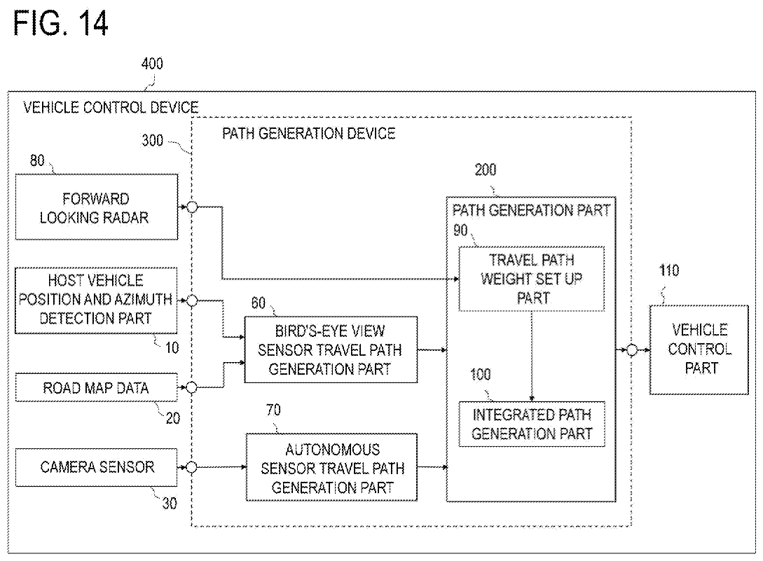

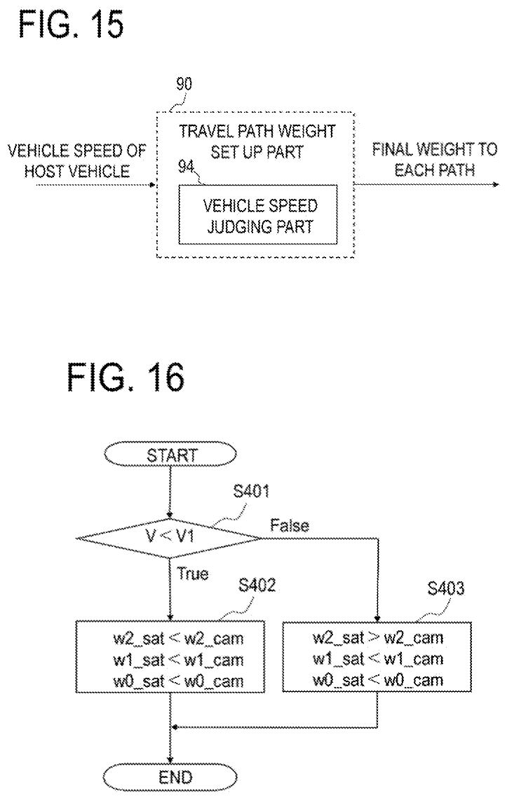

Next, explanation will be made about the Embodiment 2, based on drawings. FIG. 14 is a block diagram for showing the constitution of the vehicle control device 400 in the Embodiment 2. According to the present Embodiment, in contrast with the Embodiment 1, a vehicle speed sensor 80 is added and the output of the vehicle speed sensor 80 is input into the travel path weight set up part 90. The vehicle speed sensor 80 is the one which outputs the vehicle speed of a host vehicle, and the travel path weight set up part 90 is the one which is equipped with a vehicle speed judging part 94, as shown in FIG. 15.

Next, the overall operation of the vehicle control device 400 according to the present Embodiment will be explained. The overall flow chart here is the same as the Embodiment 1, however, the method of setting up the weight in Step S400 is different from the Embodiment 1. In the present Embodiment, the travel path weight set up part 90 sets up a weight in Step S400, based on the flow chart of FIG. 16. Below is given an explanation which will be made based on FIG. 16.

First, it is judged whether a vehicle speed V, which is input from the vehicle sensor 50, is lower than a set threshold value V1 (Step S401). When it is judged that the vehicle speed of a host vehicle is low in Step S401, the weight of an autonomous sensor travel path is set up to be higher than the weight of a bird's-eye view sensor travel path, in all of the curvature component, the angle component, and the lateral position component (Step S402). Moreover, when it is not judged that the vehicle speed of a host vehicle is low in Step S401, as for the curvature component, the weight of a bird's-eye view sensor travel path is set up to be higher than the weight of an autonomous sensor travel path, and as for the angle component and the lateral position component, the weight of an autonomous sensor travel path is set up to be higher than the weight of a bird's-eye view sensor travel path (Step S403).

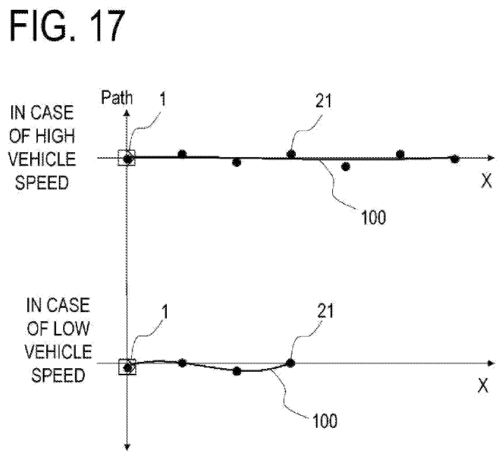

Regarding the operation of the bird's-eye view sensor travel path generation part 60 according to the present Embodiment, FIG. 17 is a drawing in which output results are compared in the cases where the vehicle speed of a host vehicle is high and low, wherein the same conditions are employed on the point sequence information of road map data. In FIG. 17, numeral 1 indicates a host vehicle. Numeral 21 indicates the target point sequence information of a host vehicle driving traffic lane, and is contained in the road map data 20. Numeral 101 indicates a bird's-eye view sensor travel path, and is a travel path which is computed out in the bird's-eye view sensor travel path generation part 60. The bird's-eye view sensor travel path 101 is a travel path which represents the relation of a target path to the host vehicle 1, by an approximated curve, using the absolute coordinate and absolute azimuth of the host vehicle 1, which are output from the host vehicle position and azimuth detection part 10, and the target point sequence information 21 of a host vehicle driving traffic lane. Here, as the vehicle speed of the host vehicle 1 is lower, a look ahead distance becomes shorter and the approximation range also becomes narrower. Then, the target point sequence of a host vehicle driving traffic lane, which is used for the computation out of an approximated curve, becomes smaller in number, and the travel path tends to be a winding one.

Like this way, according to the present Embodiment, when the vehicle speed of a host vehicle is low, the weight of an autonomous sensor travel path is set up to be higher than the weight of a bird's-eye view sensor travel path, in all of the curvature component, the angle component, and the lateral position component. Therefore, the present Embodiment is not subject to the influence of the problem mentioned above, and when the vehicle speed is low, an integrated path with an accuracy higher than the Embodiment 1 can be generated.

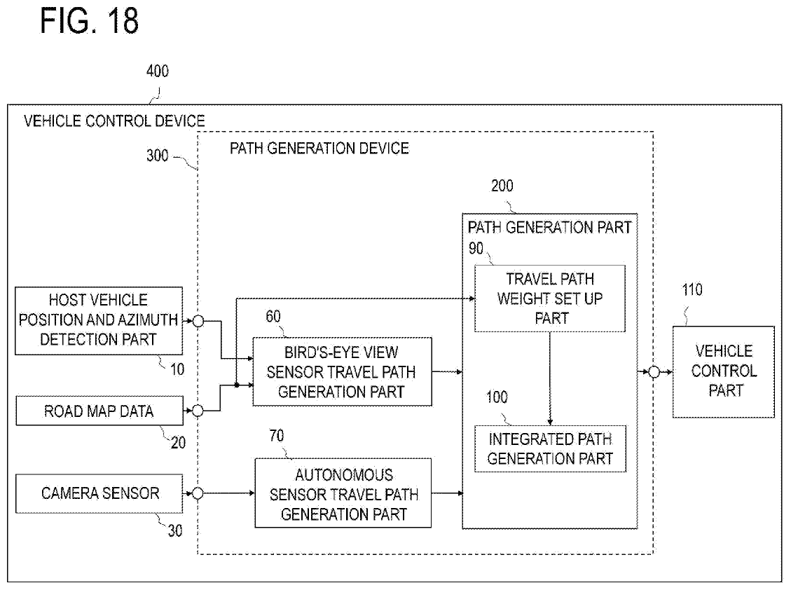

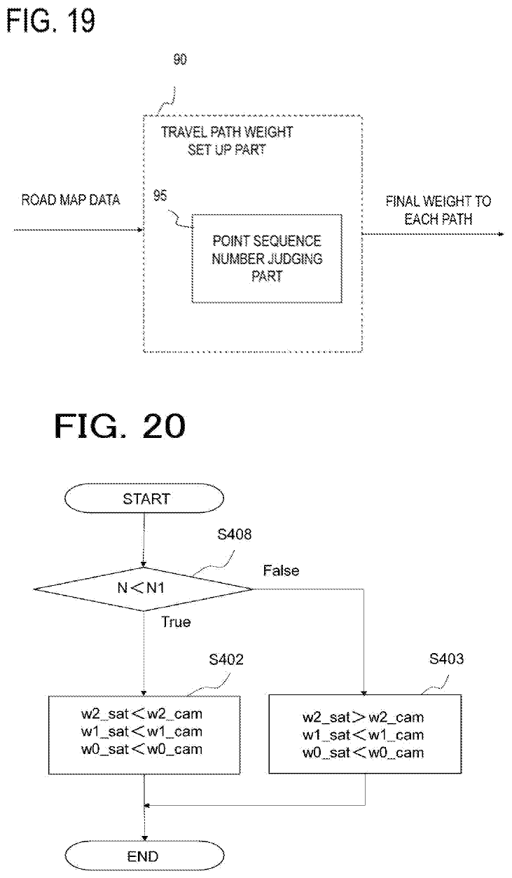

It is worth noticing that, according to the present Embodiment, when the vehicle speed of a host vehicle is low, the weight of the autonomous sensor travel path is set up to be higher than the weight of a bird's-eye view sensor travel path, in all of the curvature component, the angle component, and the lateral position component. However, it is further beneficial to judge directly whether the target point sequence of a host vehicle driving traffic lane, which is used for the computation out of an approximated curve in the bird's-eye view sensor travel path generation part 60 is small in number or not. In that case, for example, the vehicle control device 400 is configured in the constitution which is shown in FIG. 18. In addition, the travel path weight set up part 90 is equipped with a point sequence number judging part 95, as in FIG. 19. Further, the vehicle control device is configured to judge whether the target point sequence of a host vehicle driving traffic lane, which is used for the computation out of an approximated curve in the bird's-eye view sensor travel path generation part 60, is small in number or not. In Step S400, the travel path weight set up part judges, based on the flow chart of FIG. 20, whether the number of point sequence N is smaller or not than the set threshold value N1. When the travel path weight set up part judges that the number N is smaller, it is beneficial that the weight of an autonomous sensor travel path is set up to be higher than the weight of a bird's-eye view sensor travel path, in all of the curvature component, the angle component, and the lateral position component.

Moreover, in the Embodiment 1 and the Embodiment 2, the bird's-eye view sensor travel path computed out in the bird's-eye view sensor travel path generation part 60, the autonomous sensor travel path computed out in the autonomous sensor travel path generation part 70, and the integrated path are denoted by the quadratic expression which consists of the curvature component of a path, the angle component between a host vehicle and a path, and the lateral position component between a host vehicle and a path, like the Equation (1) to the Equation (6).

However, those paths are not necessarily the one which is configured in the above constitution. For example, the travel path is expressed by a cubic formula, which includes the curvature change component of a path, as a third term (the Equation (7) to the Equation (10)), and, as for the curvature change component of a path, the same weight set up as in the curvature component of a path is employed. Thereby, the same benefit as in the case when each of the travel paths is expressed by a quadratic expression can be obtained. Here, as for the symbol C2_all, the symbol C1_all, and the symbol C0_all, the same situation is true for the Equation (4) to the Equation (6), and descriptions are omitted.

### [Equation 7]

Eq. 7

path_sat(x)=C3_sat×x³+C2_sat×x²+C1_sat×x+C0_sat (7)

### [Equation 8]

Eq. 8

path_cam(x)=C3_cam×x³+C2_cam×x²+C1_cam×x+C0_cam (8)

### [Equation 9]

Eq. 9

path_all(x)=C3_all×x³+C2_all×x²+C1_all×x+C0_all (9)

### [Equation 10]

Eq. 10

C3_all=w3_sat×C3_sat+w3_cam×C3_cam (10)

(where w3_sat+w3_cam=1)

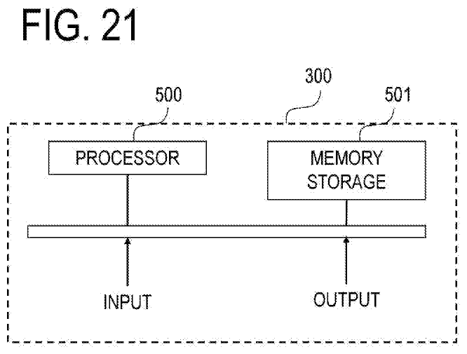

It is worth noticing that, the travel path generation device 300 consists of a processor 500 and a memory storage 501, as shown in FIG. 21, which includes an example of hardware. Although the contents of the memory storage are not illustrated, volatile storages, such as a random-access memory, and non-volatile auxiliary storage units, such as a flash memory, are provided. Moreover, the travel path generation device may be provided with an auxiliary storage unit of hard disk type, instead of a flash memory. The processor 500 executes a program which is input from the memory storage 501. In this case, the program is input into the processor 500 through a volatile memory storage from an auxiliary storage unit. Moreover, the processor 500 may output the data of an operation result and the like to the volatile memory storage of the memory storage 501, and may save data through a volatile memory storage in an auxiliary storage unit.

Although the present application is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments.

It is therefore understood that numerous modifications which have not been exemplified can be devised without departing from the scope of the present application. For example, at least one of the constituent components may be modified, added, or eliminated. At least one of the constituent components mentioned in at least one of the preferred embodiments may be selected and combined with the constituent components mentioned in another preferred embodiment.

### EXPLANATION OF NUMERALS AND SYMBOLS

1 Host vehicle; 10 Host vehicle position and azimuth detection part; 20 Road map data; 21 Target point sequence information; 22 Host traffic lane; 23 Approximation range; 24 Division line information; 25 Approximated curve; 26 Travel path; 30 Camera sensor; 40 Forward looking radar; 50 Vehicle sensor; 60 Bird's-eye view sensor travel path generation part; 70 Autonomous sensor travel path generation part; 80 Vehicle speed sensor; 90 Travel path weight set up part; 91 Tunnel entrance travel judging part; 92 Host vehicle near travel judging part; 93 Autonomous sensor travel path effective range judging part; 94 Vehicle speed judging part; 95 Point sequence number judging part; 100 Integrated path generation part; 101 Bird's-eye view sensor travel path; 110 Vehicle control part; 200 Path generation part; 300 Path generation device; 400 Vehicle control device; 500 Processor; 501 Memory storage

1. A travel path generation device, comprising;
a first path generator that outputs, based on road map data, a bird's-eye view travel path which is constituted of a bird's-eye view curvature component, a bird's-eye view angle component of a host vehicle, and a bird's-eye view lateral position component of the host vehicle,
a second path generator that outputs, based on information from a sensor which is mounted in the host vehicle, an autonomous travel path which is constituted of an autonomous curvature component, an autonomous angle component of the host vehicle, and an autonomous lateral position component of the host vehicle, and
a path generator that receives outputs of the first path generator and the second path generator; sets up a curvature component of a travel path of the host vehicle, an angle component to the travel path of the host vehicle, and a lateral position component to the travel path of the host vehicle, based on the bird's-eye view curvature component, the autonomous angle component, and the autonomous lateral position component; and generates the travel path of the host vehicle.

2. The travel path generation device according to claim 1,
wherein the path generator which includes
a travel path weight setter that carries out weighing for an adoption between the output of the first path generator and the output of the second path generator, and outputs a weight, and
an integrated path generator that carries out, based on the weight which is output from the travel path weight setter, weighing for each component of the bird's-eye view curvature component, the bird's-eye view angle component, and the bird's-eye view lateral position component, of the first path generator, and the autonomous curvature component, the autonomous angle component, and the autonomous lateral position component, of the second path generator; and generates an integrated path, and
wherein, as for the curvature component of the integrated path, the travel path weight setter sets up the weight of the bird's-eye view curvature component to be higher than the weight of the autonomous curvature component,
as for the angle component of the integrated path, the travel path weight setter sets up the weight of the autonomous angle component to be higher than the weight of the bird's-eye view angle component, and
as for the lateral position component of the integrated path, the travel path weight setter sets up the weight of the autonomous lateral position component to be higher than the weight of the bird's-eye view lateral position component.

3. A travel path generation device, comprising;
a first path generator that outputs, based on road map data, a bird's-eye view travel path which is constituted of a bird's-eye view curvature component, a bird's-eye view angle component of a host vehicle, and a bird's-eye view lateral position component of the host vehicle,
a second path generator that outputs, based on information from a sensor mounted in the host vehicle, an autonomous travel path which is constituted of an autonomous curvature component, an autonomous angle component of the host vehicle, and an autonomous lateral position component of the host vehicle, and
a path generator that receives outputs of the first path generator and the second path generator; sets up, based on the bird's-eye view curvature component, the bird's-eye view angle component, the bird's-eye view lateral position component, the autonomous curvature component, the autonomous angle component, and the autonomous lateral position component, a curvature component of a travel path of the host vehicle, an angle component to the travel path of the host vehicle, and a lateral position component to the travel path of the host vehicle; and generates the travel path of the host vehicle, and
wherein the path generator includes
a travel path weight setter that carries out weighing for an adoption between the output of the first path generator and the output of the second path generator, and outputs a weight; and
an integrated path generator that carries out, based on the weight which is output from the travel path weight setter, weighing for each component of the bird's-eye view curvature component, the bird's-eye view angle component, and the bird's-eye view lateral position component, of the first path generator, and the autonomous curvature component, the autonomous angle component and the autonomous lateral position component, of the second path generator; and generates an integrated path, and
wherein, as for the curvature component of the integrated path, the travel path weight setter sets up the weight of the bird's-eye view curvature component to be higher than the weight of the autonomous curvature component,
as for the angle component of the integrated path, the travel path weight setter sets up the weight of the autonomous angle component to be higher than the weight of the bird's-eye view angle component, and
as for the lateral position component of the integrated path, the travel path weight setter sets up the weight of the autonomous lateral position component to be higher than the weight of the bird's-eye view lateral position component.

4. The travel path generation device according to claim 2,
wherein the travel path weight setter includes a tunnel entrance travel judge that judges, based on a host vehicle position and the road map data, whether the host vehicle is travelling or not near a tunnel entrance, and
wherein, in the tunnel entrance travel judge, when it is judged that the host vehicle is travelling near a tunnel entrance from the road map data,
as for the curvature component of the travel path, the travel path weight setter sets up the weight of the bird's-eye view curvature component to be higher than the weight of the autonomous curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

5. The travel path generation device according to claim 2,
wherein the travel path weight setter includes an autonomous travel path effective range judge that judges, based on information from the sensor mounted in the host vehicle, whether an effective range of the autonomous travel path is shorter or not than a predetermined threshold value, and
wherein, in the autonomous travel path effective range judge, when it is judged that the effective range of the autonomous travel path is shorter than the threshold value,
as for the curvature component of the travel path, the travel path weight setter sets up the weight of the bird's-eye view curvature component to be higher than the weight of the autonomous curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

6. The travel path generation device according to claim 2,
wherein the travel path weight setter includes a host vehicle near travel judge that judges whether a leading vehicle is preceding or not within a predetermined distance from the host vehicle, and
wherein, in the host vehicle near travel judge, when it is judged that a leading vehicle is preceding within a predetermined distance from the host vehicle,
as for the curvature component of the travel path, the travel path weight setter sets up the weight of the bird's-eye view curvature component to be higher than the weight of the autonomous curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

7. The travel path generation device according to claim 2,
wherein the travel path weight setter includes a vehicle speed judge which judges whether a vehicle speed of the host vehicle is lower or not than a predetermined threshold value, and
wherein, in the vehicle speed judge, when it is judged that the vehicle speed of the host vehicle is lower than the threshold value,
as for the curvature component of the travel path, the travel path weight setter sets up the weight of the autonomous curvature component to be higher than the weight of the bird's-eye view curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

8. The travel path generation device according to claim 2,
wherein the travel path weight setter includes a point sequence number judge that judges whether the number of point sequence of road map data is smaller than a predetermined threshold value, where the point sequence is contained within a predetermined distance from the host vehicle, and is computed out according to the vehicle speed of the host vehicle, and
wherein in the point sequence number judge, when it is judged that the number of point sequence of road map data is smaller than the threshold value, where the point sequence is contained within the predetermined distance from the host vehicle, and is computed out according to the vehicle speed of the host vehicle,
as for the curvature component of the travel path, the travel path weight setter sets up the weight of the autonomous curvature component to be higher than the weight of the bird's-eye view curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

9. The travel path generation device according to claim 2,
wherein the bird's-eye view travel path which the first path generator outputs, the autonomous travel path which the second path generator outputs, and the integrated path which the integrated path generator generates, are each constituted of a curvature change component of a path, a curvature component of the path, the angle component between the host vehicle and the path, and a lateral position component between the host vehicle and the path, and
as for the curvature change component of the travel path which constitutes the bird's-eye view travel path, the autonomous travel path, and the integrated path, the travel path weight setter sets up the same weight as the curvature component of the travel path.

10. The travel path generation device according to claim 3,
wherein the travel path weight setter includes a tunnel entrance travel judge that judges, based on a host vehicle position and the road map data, whether the host vehicle is travelling or not near a tunnel entrance, and
wherein, in the tunnel entrance travel judge, when it is judged that the host vehicle is travelling near a tunnel entrance from the road map data,
as for the curvature component of the travel path, the travel path weight setter sets up the weight of the bird's-eye view curvature component to be higher than the weight of the autonomous curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

11. The travel path generation device according to claim 3,
wherein the travel path weight setter includes an autonomous travel path effective range judge that judges, based on information from the sensor mounted in the host vehicle, whether an effective range of the autonomous travel path is shorter or not than a predetermined threshold value, and
wherein, in the autonomous travel path effective range judge, when it is judged that the effective range of the autonomous travel path is shorter than the threshold value,
as for the curvature component of the travel path, the travel path weight setter sets up the weight of the bird's-eye view curvature component to be higher than the weight of the autonomous curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

12. The travel path generation device according to claim 3,
wherein the travel path weight setter includes a host vehicle near travel judge that judges whether a leading vehicle is preceding or not within a predetermined distance from the host vehicle, and
wherein, in the host vehicle near travel judge, when it is judged that a leading vehicle is preceding within a predetermined distance from the host vehicle,
as for the curvature component of the travel path, the travel path weight setter sets up the weight of the bird's-eye view curvature component to be higher than the weight of the autonomous curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

13. The travel path generation device according to claim 3,
wherein the travel path weight setter includes a vehicle speed judge which judges whether a vehicle speed of the host vehicle is lower or not than a predetermined threshold value, and
wherein, in the vehicle speed judge, when it is judged that the vehicle speed of the host vehicle is lower than the threshold value,
as for the curvature component of the travel path, the travel path weight setter sets up the weight of the autonomous curvature component to be higher than the weight of the bird's-eye view curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

14. The travel path generation device according to claim 3,
wherein the travel path weight setter includes a point sequence number judge that judges whether the number of point sequence of road map data is smaller than a predetermined threshold value, where the point sequence is contained within a predetermined distance from the host vehicle, and is computed out according to the vehicle speed of the host vehicle, and
wherein in the point sequence number judge, when it is judged that the number of point sequence of road map data is smaller than the threshold value, where the point sequence is contained within the predetermined distance from the host vehicle, and is computed out according to the vehicle speed of the host vehicle,
as for the curvature component of the travel path, the travel path weight setter sets up the weight of the autonomous curvature component to be higher than the weight of the bird's-eye view curvature component,
as for the angle component of the travel path, the travel path weight setter sets up the weight of the autonomous angle component to be higher than the weight of the bird's-eye view angle component, and
as for the lateral position component of the travel path, the travel path weight setter sets up the weight of the autonomous lateral position component to be higher than the weight of the bird's-eye view lateral position component.

15. The travel path generation device according to claim 3,
wherein the bird's-eye view travel path which the first path generator outputs, the autonomous travel path which the second path generator outputs, and the integrated path which the integrated path generator generates, are each constituted of a curvature change component of a path, a curvature component of the path, the angle component between the host vehicle and the path, and a lateral position component between the host vehicle and the path, and
as for the curvature change component of the travel path which constitutes the bird's-eye view travel path, the autonomous travel path, and the integrated path, the travel path weight setter sets up the same weight as the curvature component of the travel path.
